(19) United States
(12) Patent Application Publication
(10) Pub. No.: US 2021/0016149 A1
(43) Pub. Date: Jan. 21, 2021

(54) Systems and Methods for Athletic Performance Assessment and Training

(71) Applicants: Dalton Young, Oklahoma City, OK (US); Jeff Nelson, Fife, WA (US)

(72) Inventors: Dalton Young, Oklahoma City, OK (US); Jeff Nelson, Fife, WA (US)

(21) Appl. No.: 17/061,546

(22) Filed: Oct. 1, 2020

Related U.S. Application Data
(63) Continuation-in-part of application No. 15/002,797, filed on Jan. 21, 2016, now abandoned.
(60) Provisional application No. 62/106,105, filed on Jan. 21, 2015.

(51) Int. Cl. A63B 71/06; A63B 24/00

(52) U.S. Cl. CPC A63B 71/0616; A63B 71/0622; A63B 24/0062; A63B 2220/40; A63B 2024/0068; A63B 2220/53; A63B 2225/50; A63B 2243/007; A63B 2220/34

(57) ABSTRACT

An athletic performance training and assessment system comprising an accelerometer configured to measure linear acceleration of the athlete and a gyroscope configured to measure angular velocity of the athlete. A processor is configured to calculate a reaction time of the athlete by comparing a baseline score measured prior to commencement of the athletic training drill with a time stamp of a first peak value above the baseline score after commencement of the athletic training drill, receive a plurality of pressure readings from a pressure sensor comprising a strike magnitude and a strike time stamp and calculate an impact score for the athlete, and calculate an athlete ranking based on reaction time and impact score. The processor is further configured to assign an athletic training drill based on at least one of the athlete ranking, the reaction time and the impact score previously collected by the processor.

### CROSS REFERENCE TO RELATED APPLICATIONS

This document is a continuation in part of U.S. application Ser. No. 15/002,797 entitled “Systems and Devices for Training and Assessment of Football Players” to Dalton Young, et al., which was filed on Jan. 21, 2016 which claims the benefit of the filing date of U.S. Provisional Patent Application No. 62/106,105, entitled “Systems and Devices for Training and Assessment of Football Players” to Dalton Young, et al., which was filed on Jan. 21, 2015, the disclosures of which are hereby incorporated entirely by reference herein.

### BACKGROUND

### 1. Technical Field

Aspects of this document relate generally to systems and methods for training athletes and assessing athletic performance.

### 2. Background Art

Athletic performance is commonly measured using data collection and creation of various past performance statistics. This statistical information is often used by schools, universities, leagues, and professional sports teams to assess the relative performance of various athletes which may be a factor in athletic player selection.

Current athletic performance assessment and training systems provide limited information for certain player positions only. For example, current statistics commonly track the number of completed passes that a football quarterback has and a number of points and rebounds made by a basketball player, but many other position statistics are not readily recorded and/or reportable.

### SUMMARY

Implementations of an athletic performance training and assessment system may comprise a computerized mobile device comprising an input device configured to receive one or more demographic characteristics of an athlete and a selection of one or more athletic training drills by the athlete, an accelerometer configured to measure linear acceleration of the athlete, a gyroscope configured to measure angular velocity of the athlete, and a magnetometer configured to detect an orientation of the computerized mobile device. The computerized mobile device may further comprise a processor configured to calculate a reaction time of the athlete by comparing a baseline score using data obtained from the gyroscope, magnetometer, and accelerometer, by comparing a baseline score measured prior to commencement of the athletic training drill with a time stamp of a first peak value above the baseline score after commencement of the athletic training drill, receive a plurality of pressure readings from a pressure sensor comprising a strike magnitude and a strike time stamp and calculate an impact score for the athlete, calculate an athlete ranking based on reaction time and impact score, and assign an athletic training drill based on at least one of the athlete ranking, the reaction time and the impact score previously collected by the processor. The computerized mobile device may further comprise a wireless interface configured to transmit the athlete ranking and data collected for the athlete during the athletic training drill to an athlete database and a display configured to display that athlete ranking and athletic drill training data.

Particular aspects may comprise one or more of the following features. The impact score may be based on motion occurring in three axes and is calculated as a square root of a sum of squares of a magnitude of each of the three axes. The athlete ranking may be based on at least one of a team, a league, a division, and an age bracket. The input device may be further configured to receive a time period input from the athlete over which the athletic training drill is repeated and the athlete ranking is generated based on at least one of an average reaction time and an average impact score over the time period. The processor may be further configured to calculate at least one of an improvement or a diminishment in at least one of an average of a reaction time or an impact score of a most recent athletic training drill session as compared to the at least one of the average reaction time and the average impact score over the time period input by the athlete and display the at least one of the improvement or the diminishment on the display of the computerized mobile device.

The processor may be further configured to assign a validation athletic training drill to the athlete when the at least one of the improvement or diminishment in at least one of an average of a reaction time or an impact score is within an expected range for athletic training progress of the athlete. The processor may assign an athletic training drill of a greater difficulty level in response to a positive validation performance by the athlete on the validation athletic training drill. The processor may assign an athletic training drill of a lesser difficulty level in response to a negative validation performance by the athlete on the validation athletic training drill. The system may further comprise displaying an athlete ranking for all athletes within the at least one of a team, a league, a division, or an age bracket.

The processor may be further configured to calculate an athletic performance score based on a weighted average of the reaction time and impact score of the athlete and generate and display an athlete ranking based on the calculated athletic performance score.

Implementations of a method of athletic performance training and assessment may comprise receiving, one or more demographic characteristics of an athlete and a selection of one or more athletic training drills by the athlete by an input device of a computerized mobile device, the computerized mobile device comprising an accelerometer configured to measure linear acceleration of the athlete, a gyroscope configured to measure angular velocity of the athlete; and a magnetometer configured to detect an orientation of the computerized mobile device. The method may further comprise calculating, by a processor of the computerized mobile device, a reaction time of the athlete using data obtained from the gyroscope, magnetometer, and accelerometer, by comparing a baseline score measured prior to commencement of the athletic training drill with a time stamp of a first peak value above the baseline score after commencement of the athletic training drill, receiving, by the processor, a plurality of pressure readings from a pressure sensor comprising a strike magnitude and strike timestamp and calculating an impact score for the athlete; and calculating, by the processor, an athlete ranking based on the reaction time and the impact score. The method may further comprise transmitting, by a wireless interface, the athlete ranking and data collected for the athlete during the athletic training drill to an athlete database, displaying, on a display of the computerized mobile device the athlete ranking and athletic drill training data and assigning, by the processor, an athletic training drill based on at least one of the athlete ranking and the athletic drill training data previously collected by the processor.

Particular aspects may comprise one or more of the following features. The impact score may be based on motion occurring in three axes and may be calculated as a square root of a sum of squares of a magnitude of each of the three axes. The athlete ranking may be based on at least one of a team, a league, a division, and an age bracket. The method may further comprise receiving a time period input from the athlete over which the athletic training drill is repeated and generating the athlete ranking based on at least one of an average reaction time and an average impact score over the time period. The method may further comprise calculating, by the processor, at least one of an improvement or a diminishment in at least one of an average of a reaction time or an impact score of a most recent athletic training drill session as compared to the at least one of the average reaction time and the average impact score over the time period input by the athlete and displaying the at least one of the improvement or the diminishment on the display of the computerized mobile device.

The method may further comprise assigning, by the processor, a validation athletic training drill to the athlete when the at least one of the improvement or diminishment in at least one of an average of a reaction time or an impact score is within an expected range for athletic training progress of the athlete. The method may further comprise assigning, by the processor, an athletic training drill of a greater difficulty level in response to a positive validation performance by the athlete on the validation athletic training drill. The method may further comprise assigning, by the processor, an athletic training drill of a lesser difficulty level in response to a negative validation performance by the athlete on the validation athletic training drill. The method may further comprise displaying an athlete ranking for all athletes within the at least one of a team, a league, a division, or an age bracket. The method may further comprise calculating, by the processor, an athletic performance score based on a weighted average of the reaction time and impact score of the athlete and generating and displaying an athlete ranking based on the calculated athletic performance score.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explains how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of post-AIA 35 U.S.C. § 112(f). Thus, the use of the words “function,” “means” or “step” in the Description, Drawings, or Claims is not intended to somehow indicate a desire to invoke the special provisions of post-AIA 35 U.S.C. § 112(f), to define the invention. To the contrary, if the provisions of post-AIA 35 U.S.C. § 112(f) are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of post-AIA 35 U.S.C. § 112(f). Moreover, even if the provisions of post-AIA 35 U.S.C. § 112(f) are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 shows a schematic view of an example of a programmable computing device.

FIG. 2 shows a schematic view of an example of a mobile electronic device.

FIG. 3 shows a schematic view of a first example of an athletic training and assessment system.

FIG. 4 shows a flowchart depicting the steps for athletic training and assessment according to an embodiment of the present invention.

FIGS. 5-6 provide exemplary views of an athlete's scorecard as displayed on a computerized device.

### DESCRIPTION

This disclosure, its aspects and implementations, are not limited to the specific components or methods disclosed herein. Many additional components and assembly procedures known in the art consistent with the intended athletic assessment and training system and related methods will become apparent for use with particular implementations from this disclosure. Accordingly, for example, although particular implementations are disclosed, such implementations and implementing components may comprise any components, models, versions, quantities, and/or the like as is known in the art for such systems and implementing components, consistent with the intended operation.

The disclosed athletic training and assessment systems and devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of athletic training and assessment systems and method examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

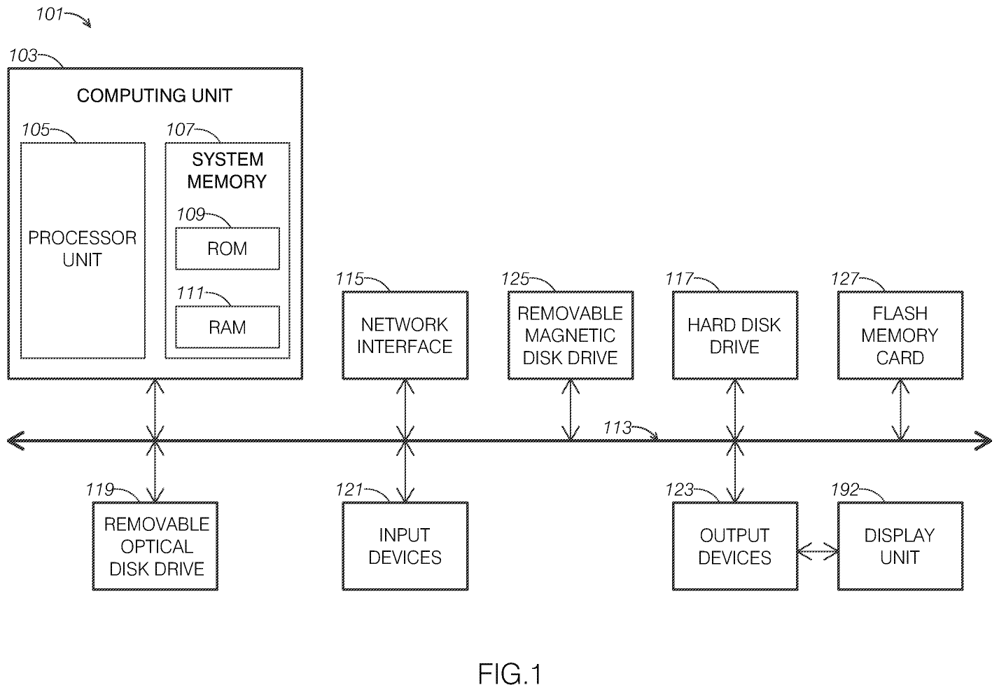

With reference to FIGS. 1-6, a exemplary embodiments of an athletic training and assessment system 300, will now be described. Training and assessment system 300 functions to provide a mechanism for collecting data for one or more athletes that can be used during training to improve technique and play for individuals and/or for a team. Additionally or alternatively, athletic training and assessment system 300 can be used to collect and report statistics for individual athletes.

Athletic training and assessment system 300 addresses many of the shortcomings existing with athletic training and assessment systems and devices. For example, while the athletic training and assessment system may be used in association with any sport or fitness regimen, for illustrative purposes, in the non-limiting context of football, data for dash times and/or blocking (i.e., tackling) forces can be collected for linemen and other players that are in more difficult positions to collect data for. In another example, data collection can be recorded for a single player, individual players in a team, and/or for a team as a whole.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

Accordingly, FIG. 1 shows a non-limiting illustrative example of a computer 101, which can be used to implement various embodiments of the invention. Computer 101 may be incorporated within a variety of consumer electronic devices, such as personal media players, cellular phones, smart phones, personal data assistants, global positioning system devices, fitness trackers, and the like.

As seen in FIG. 1, computer 101 comprises a computing unit 103. Computing unit 103 typically comprises a processing unit 105 and a system memory 107. Processing unit 105 may be any type of processing device for executing software instructions, but may conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 may be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android or Windows or other OS based smartphone or wearable device. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS or Windows or other OS based smartphone or wearable device or operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

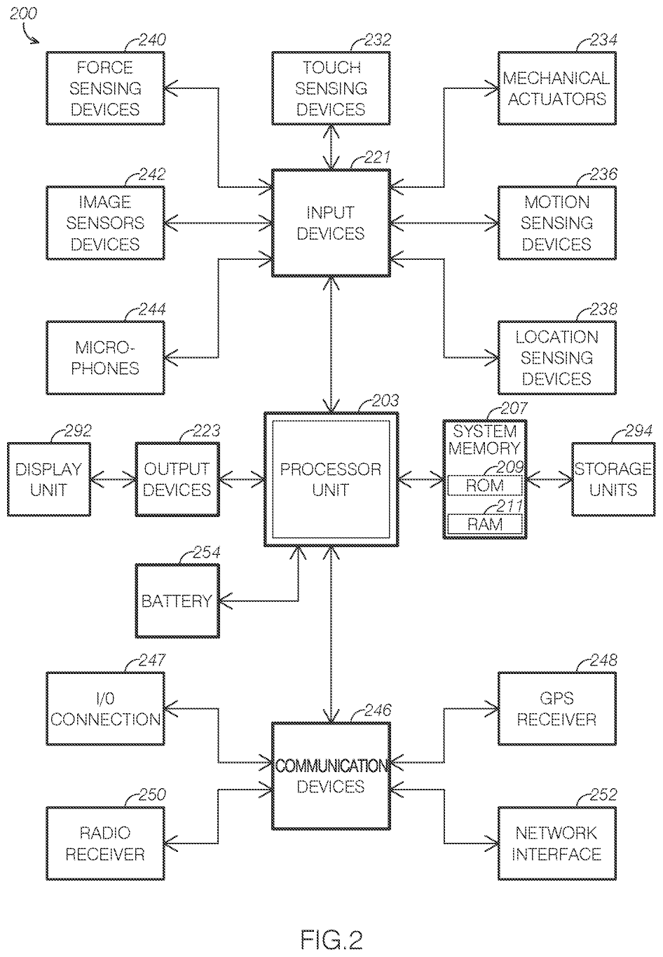

With reference to FIG. 2, an exemplary mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including a dedicated or embedded processor, or a single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such as iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 may also include input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers and gyroscopes; location detecting devices 238 such as global positioning satellite receivers, magnetometers, WiFi based location detection functionality, or cellular radio based location detection functionality; force sensing devices such as force sensitive displays and housings; image sensors; and microphones. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 may also include a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

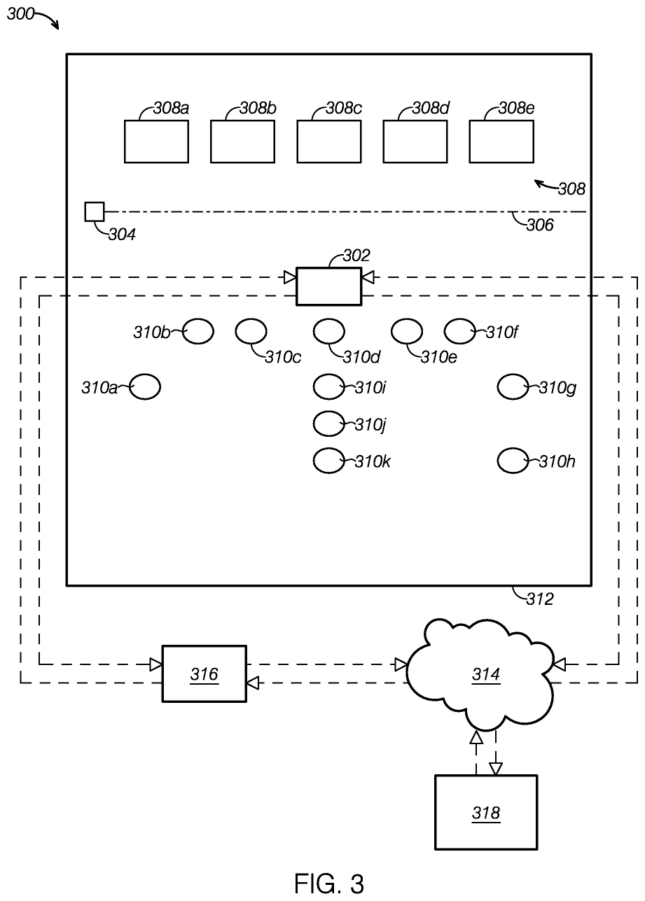

Turning now to FIG. 3, training and assessment system 300 may comprise a timing and data collection device 302, a position sensing device 304 that senses timing of a disruption of a virtual line 306, and impact pressure sensing devices 308 (308 a-308 e) for use with a plurality of athletes 310 (310 a-310 k) involved in a training and/or assessment exercise. The various components of the training assessment system and the athletes described above may be located on a playing field 312 or other training grounds.

In some examples, the training and assessment system can include more or fewer impact pressure sensing devices, or even exclude impact pressure sensing devices. Additionally or alternatively, each of the players can carry an electronically-readable unique tag that can be read by the position sensing device. In some other examples, the training and assessment system can exclude the position sensing device and instead use a timing of impact against the impact pressure sensing devices to collect timing data. It will be appreciated that the training and assessment system can be used to assess a single player or a group of players according to the user's needs. The training and assessment system can be used with as few as one athlete, to an entire team or even groups of teams.

In still other examples, the training and assessment system can include a separate data collection device that is remote relative to the timing device and/or the playing field or other training grounds, such as a personal computer 316. It should be understood that the present invention does not require an actual laser line (as created by, for example, a laser pointer) for proper operation of the system. Some embodiments may utilize an accelerometer that is built into a smart phone or wearable fitness device. As depicted in FIG. 3, timing and data collection device 302 can be in communication with a network location 314 and/or a personal computer 316. Further, personal computer 316 may be in communication with network location 314. Furthermore, network location 314 may be in communication with a database 318 for storage of collected data and/or various training and assessment programs that can be used with training and assessment system 300.

As can be seen in FIG. 3, timing and data collection device 302 may be substantially located in front of athletes 310. In the present example, the timing and data collection device is a computer, such as computer 101 or mobile device 200 described above. The timing and data collection device can wirelessly communicate (e.g., via Bluetooth, WiFi, etc.) with the position sensing device, the impact pressure sensing devices, the network location, and/or the personal computer. In other examples, the timing and data collection device can be in wired communication with the position sensing device, the impact pressure sensing devices, the network location, and/or the personal computer.

The timing and data collection device may be configured to provide a start signal that represents sound that may be similar to what an athlete may hear during a game or race, such as by non-limiting example, a simulated snap of a football (i.e., a beginning of a play). A timing of the signal to initiate play can be randomized so that the athletes cannot anticipate when the signal will be emitted. In some examples, the signal may be a visual signal (e.g., a blink of a light, a change of color of a light, etc.). Alternatively or additionally, the timing and data collection device can provide an auditory signal (e.g., a buzz, a beep, a simulated countdown, etc.). In some examples, the timing and data collection device may be configured in the shape of game ball or other item used in the playing of a sport.

After receiving the signal from timing and data collection device 302, athletes 310 can then initiate a training play. For example, athletes 310 can run forward towards virtual line 306 and impact pressure sensing devices 308. Data can then be recorded for a timing of one or more the athletes to pass virtual line 306 and/or pressure of body impact for one or more of the athletes against impact pressure sensing devices 308.

In the example shown in FIG. 3, position sensing device 304 is configured to project virtual line 306 across the playing field 312. The position sensing device may be a laser and the virtual line can be a path of the laser beam. A disruption of the laser beam (e.g., a player running through the laser beam) can be used to record a timing of a play by one or more of the athletes. In one example, timing is measured for each player individually by the laser reading an electronically-readable unique tag carried by each of the players. In another example, the laser can read and record a general start of play and/or a general end of play for all of the athletes collectively. Alternatively, if the system is used with only a single athlete, a single timing of disruption of the laser beam can be recorded.

After crossing virtual line 306, one or more of the athletes can simulate a tackle or other athletic maneuver by running into impact pressure sensing devices 310. In one example, the impact pressure sensing devices are padded dummies that are generally the size and/or shape of a human. In another example, the impact pressure sensing devices are elongate vertically arranged pads configured to receive a shoulder of an oncoming athlete during a training session. In both of these examples, the impact pressure sensing devices are configured to measure and record a pressure of the force of impact exerted by an athlete onto the device (e.g., an impact force in pound-force per square inch [psi]). In some examples, the impact pressure sensing devices are configured to read the electronically-readable tag attached to each of the athletes and record the impact pressure specific to each athlete.

It will be appreciated that the timing and data collection device can be used to run subsequent training sessions. In some examples, the timing and data collection device is set to automatically run a new simulated snap at specific intervals (e.g., 2 mins, 3 mins, 5 mins, etc.). In other examples the timing and data collection device can be manually activated to begin a new start signal. Further, it will be appreciated the collected data (e.g., timing data and/or impact force data described above) can be stored in the timing and data collection device and/or sent to one or more of the network location, the database, and the personal computer. Furthermore, the data can be analyzed to determine statistical information for one or more of the athletes individually and/or the athletes collectively. Further still, statistical information can be used for performance evaluation.

In one specific example of use for training and assessment system 300, athletes such as football players 310 b and 310 f are in “tackle” positions. Each of the athletes carries a unique electronically-readable tag that is attached to the wrist of an athlete via an elastic band. They athletes are aligned in a desired play pattern along a starting line. A coach or trainer initiates training and assessment system 300 via a command through personal computer 316 that is in wireless communication with timing and data collection device 302.

After a randomized delay period, a visual signal of a change in light coloration from red to green is emitted from timing and data collection device 102. Play is initiated and athletes 310 b and 310 f run towards virtual line 306. A timing of each athlete crossing virtual line 306 (i.e., timing data) is recorded by timing and data collection device 302 via reading of each of the unique electronically-readable tags by position sensing device 304.

Athlete 310 b then simulates a tackle into impact pressure sensing device 310 a, while athlete 310 f simulates a tackle into impact pressure sensing device 310 e. An impact pressure exerted by each of the athletes (i.e., impact pressure data) is recorded by timing and data collection device 302 via reading of each of the unique electronically-readable tags by impact pressure sensing devices 310 (i.e., impact pressure sensing devices 308 a and 308 e).

Timing data and impact pressure data for each of the athletes is then sent to personal computer 316 and network location 314. Further, timing data and impact pressure data for each of the athletes is sent to database 318. Within database 318 the data can be combined with data from additional team and/or athlete data to calculate national and regional averages. Further, data for each of the athletes can be stored and later reported to recruiters.

It will be appreciated that the above described example is just one possible use for training and assessment system 300. It will be further appreciated that the system is dynamic and can be adapted for training or assessment of a single athlete and/or adapted for specific desired training conditions selected by a coach or trainer.

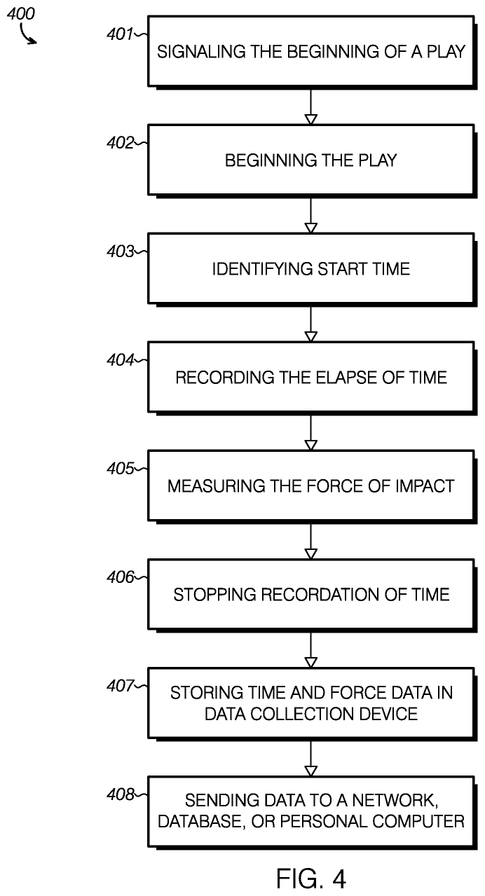

FIG. 4 shows a flowchart that represents a typical implementation of training and assessment system 300 according to an embodiment of the present invention. It should be understood that training and assessment system 300 may be operated by any person regardless of his or her connection with a team or an athlete. In this manner, training and assessment system 300 may be operated by an athlete, a coach, or any other individual interested in benefiting from the object of the present invention.

In some embodiments, training and assessment system 300 comprises the steps of 401 signaling the beginning of a play or exercise; 402 beginning the play or exercise; 403 identifying start time at the beginning of the play or exercise and when each athlete passes virtual line 306; 404 recording the elapse of time; 405 measuring the force with which each athlete contacts pressure sensing device 308; 406 stopping the recordation of time and calculating total time, which is the total time from beginning to end of the play; sending the data for time and force to the network, the database, and/or the personal computer. In alternative embodiments, training and assessment system 300 may skip the step of measuring the force of impact and simply measure the amount of time it takes for the athlete to execute a play or exercise.

Step 401—signalling the beginning of the play or exercise—includes identifying the point at which the athlete 310 begins execution of the play or other exercise. As mentioned above, it can include a visual signal such as a blinking light or an auditory cue such as a whistle or beep. At this point, the athletes start (step 402) and move about behind the virtual line 306. When an athlete crosses virtual line 306 that is created by the position sensing device 304, the pressure sensing device 304 will interact with an electronically readable tag worn by the athlete and is recorded. In alternative embodiments, data collection device 302 and pressure sensing device may be manually activated to begin and end recording.

In some embodiments, the play or exercise ends when the athlete interacts with pressure sensing device (step 405). The resultant data that is collected may be stored directly in data collection device and/or sent to a network location, a database, or a personal computer (steps 408). Thus, the user is free to analyze the collected data to evaluate an athlete, group of athletes, or team's overall performance. In alternative embodiments, a play or exercise can end manually (such as, for example, by an auditory or visual cue like a whistle or a laser).

In alternative embodiments (not shown), an athlete may self-assess using a uniquely designed software application on his or her own smart device. In those embodiments, an athlete may attach the smart device and/or additional accelerometer device to a part of the body, such as a forearm or upper arm. The athlete then ensures that the app and potential added accelerometer device are powered on and connecting. The athlete starts a software application using appropriate steps for the OS on the smart device. When the athlete is ready to begin a training event, s/he selects the drill, and taps a radio button marked “ready.” After a randomized period of time, the application gives a start signal. The athlete then executes a play or other exercise in the manner described above. Thus, the application works with the smart device's accelerometers to measure, for example, reaction time between the time of the start signal and the start of motion, time between start of motion and impact on the target, and other desirable data.

In some embodiments, an athlete may utilize his or her own computerized device such as a smart phone, tablet, fitness tracker, etc. that is equipped with one or more of the following sensors: an accelerometer; a gyroscope, a barometer, a temperature sensor, a magnetometer, and a multi-axis orientation sensor. When the athlete chooses to begin a particular exercise or drill, the athlete's computerized device issues a command to the athlete to “get set and be still.” A clock may then start on a random timer that runs for a predetermined time period such as, by non-limiting example, between about 0.5 and about 2.5 seconds. During this time period, but computerized device determines an arithmetic mean of data previously collected to provide a baseline accelerometer score. This baseline accelerometer score becomes the baseline used to determine when action events occur. If the athlete moves during this time period, the athlete must start over to allow the computerized device to properly calculate the baseline accelerometer score. Similarly, baseline data may be collected form the gyroscope and the magnetometer and used in conjunction with the baseline accelerometer data to calculate a baseline score.

The athlete's computerized device emits an audible or visual start signal to indicate that the athlete is to begin the exercise or drill. The computerized device uses a timestamp of the start signal and a timestamp of a first peak above the baseline to calculate a reaction time for the athlete. As the athlete progresses through a drill or exercise, the athlete may strike one or more targets using the athlete's hands, arms, shoulders, feet, legs, etc. The computerized device records a timestamp and magnitude of each strike. When the athlete has completed the drill or exercise, the athlete returns to the starting point and if desired selects an option to “start next turn” on the athlete's computerized device to begin another turn of the drill or exercise. The athlete's computerized device then records the athlete's prior reaction time and impact magnitudes with a time stamp corresponding to the prior turn of the drill or exercise. In some embodiments, the athlete's computerized device may also calculate a travel time between action events by calculating a difference in timestamps between action events.

The athlete may continue to repeat turns in a drill or exercise or select an option to move on to a different drill or exercise. When the athlete chooses to end a drill or exercise session, the athlete selects an option to “end the session” on the athlete's computerized device and the set of dated and time stamped data is recorded by the athlete's computerized device. This data may be stored locally or may be transmitted via cellular data or other wireless or wired Internet connection to a remote server and database. An updated ranking and/or athlete scorecard may be displayed on the computerized device of the athlete.

In some embodiments of the performance training and assessment system, the system may compare data from one or more drills or exercises or one or more sets of drills or exercises with historical data about the athlete's prior performance to measure the athlete's training progress. The system may also update a suggested training plan based on the athlete's performance and training progress.

An athlete or other user may enter one or more items of demographic data about the athlete using the athlete's computerized device. Non-limiting examples include the athlete's name, age, height, weight, location, team name and/or year in school. The system maintains an overall data record for each athlete in the system, non-limiting example of which is shown in the table below:

| | Drill | Reaction | Travel | Impact | Travel | Impact |
|---|---|---|---|---|---|---|
| Date | Name | Time | Time 1 | Score 1 | Time 2 | Score 2 |
| | | 299.89 | 1169.94 | 73.41 | 1240 | 72.00 |
| | | 299.87 | 764.41 | 61.81 | 924 | 25 |
| | | 299.85 | 976.3 | 51.37 | 1129 | 53 |

Each row of the table above represents data collected from one execution or turn of a given drill or exercise. Not all drills or exercises may reflect data in every column and in such instances some spaces in the table may be blank. A blank space simply represents that no data is present and does not equate to a score of zero. Athletes may complete a predetermined series of turns of a given drill or exercise on a given date.

Reaction time reflects the number of milliseconds that transpire between a start signal and a first significant motion detected by the accelerometer, thus any given drill or exercise comprises only a single reaction time.

Impact scores reflect the g-force detected when an athlete strikes a target with their hands, another body part, or sports equipment such as a racquet or bat. The system is configured to detect the strike magnitude components based on motion in the x-, y-, and z-axes and mathematically collapse these three component measurements into a single strike magnitude score according to the following formula:

Magnitude=sqrt(x\hat{ }2+y\hat{ }2+z\hat{ }2)

where x, y, and z represent a magnitude of each component axis.

An impact time stamp is also collected by the system based on the time at which the athlete impacted one or more pressure sensors.

Drills or exercises may comprise a plurality of impact scores which are then utilized in the calculation of the athlete's average impact store for a particular drill or exercise. Such average impact scores may be used to rank athletes against other athletes based on their impact scores alone or in combination with reaction time and/or other indicators of an athlete's physical performance.

In some embodiments, when an athlete performs a prescribed set of training drills or exercises for the day, the system recalculates a rolling average for each metric individually (e.g. reaction time and impact score in g-force) for a predetermined time period and resets the high scores of an athlete if the athlete's most recent score(s) exceeds a prior high score. These scores may then be used to rank an athlete against the athlete's peers as designated by category, age bracket, team, league, etc.

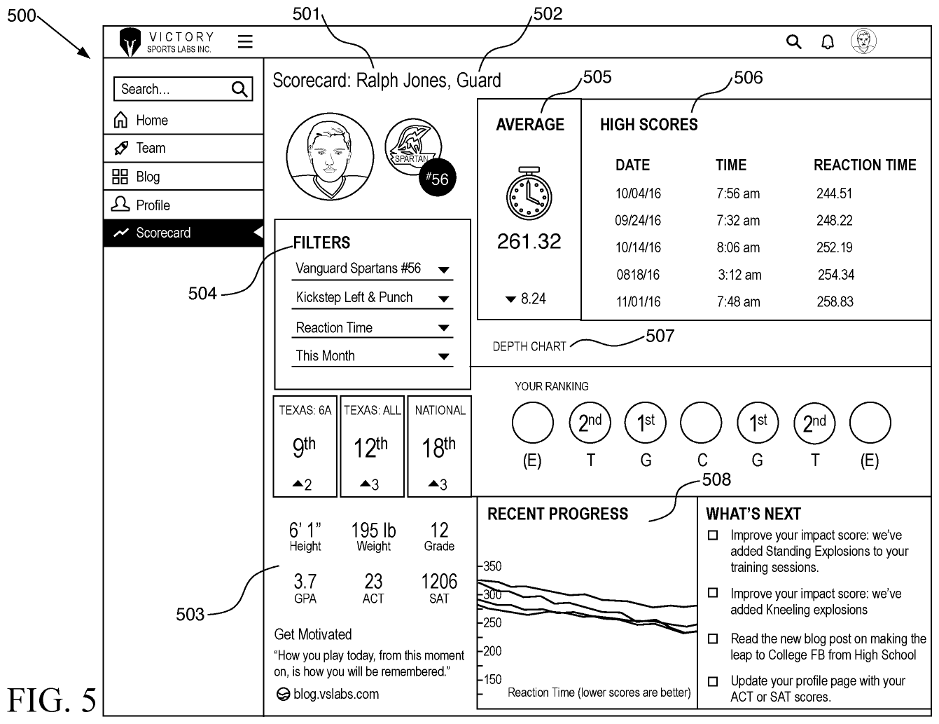

An athlete's ranking and performance information may be displayed on the athlete's computerized mobile device or other computing device via a web interface. A non-limiting example of an athlete's scorecard 500 is provided for illustrative purposes in FIG. 5. While this exemplary scorecard depicts the athlete as a football player, it is intended that the system is applicable to athletes participating in any sport or training event. As shown here, in addition to the athlete's name 501 and position 502, the athlete or other user of the system may also input demographic information 503 such as the athlete's height, weight, grade, and academic standing. The athlete may enter one or more teams to which the athlete belongs and may enter one or more positions played on each team.

The system is configured to display one or more filtering options that are relied upon to limit the data set so as to create meaningful athlete performance rankings based on reaction time, impact score, and any other relevant performance measurement. Each athlete's scorecard is accessible by the athlete as well as other parties who are seeking to gauge the athlete's overall performance and ranking against the athlete's peers such as for example, coaches, trainers, recruiters, etc. Here, the filters have been set to show results only for this particular athlete whose team is the Vanguard Spartans and the athlete's jersey number is 56. To record the athlete's performance over the duration of a particular drill or exercise, the athlete selects the drill, here shown as “Kickstep Left & Punch” and then performs the drill while the system records the athlete's reaction time and/or impact scores. The system calculates the average reaction time score of the athlete's kickstep left & punch drill based on the selected filter “This Month” for the past month, however, it is contemplated that any relevant time frame may be used. Accordingly, based on the selected filters, the average and best scores for reaction time are displayed, however, if a different filter was selected, other recorded data may be displayed. As shown, a positive or negative change in the average may be displayed as compared with the prior month, 30-day time period, or other relevant time period. Here, the athlete's average reaction time decreased by 8.24 milliseconds which represents an improvement in the athlete's performance.

A depth chart 507 may be visible on the athlete's scorecard which allows the athlete to see the athlete's ranking based on that athlete's filter selection such as by team, position, drill, and timeframe, of the athlete's personal scores in the database. Scorecards are also available for viewing by coaches and recruiters who may view information such as a team depth chart that shows the ranking that each athlete on the team who is completing training drills or exercises through the system has. This information may be invaluable to a coach or recruiter in determining how to best build a team and assign player positions. Additionally, based on the filters selected, additional rankings may be displayed. As shown in FIG. 5, this athlete ranks 9^{th} among Texas high school football division 6A, 12^{th} overall among Texas high school football players, and 18^{th} nationally in his reaction time over the past month on the kickstep left & punch drill.

Additionally, the scorecard may provide a graphical or other depiction 508 of an athlete's performance progress over time as well as suggestions or reminders of additional drills, exercises, or tasks that may further improve the athlete's performance.

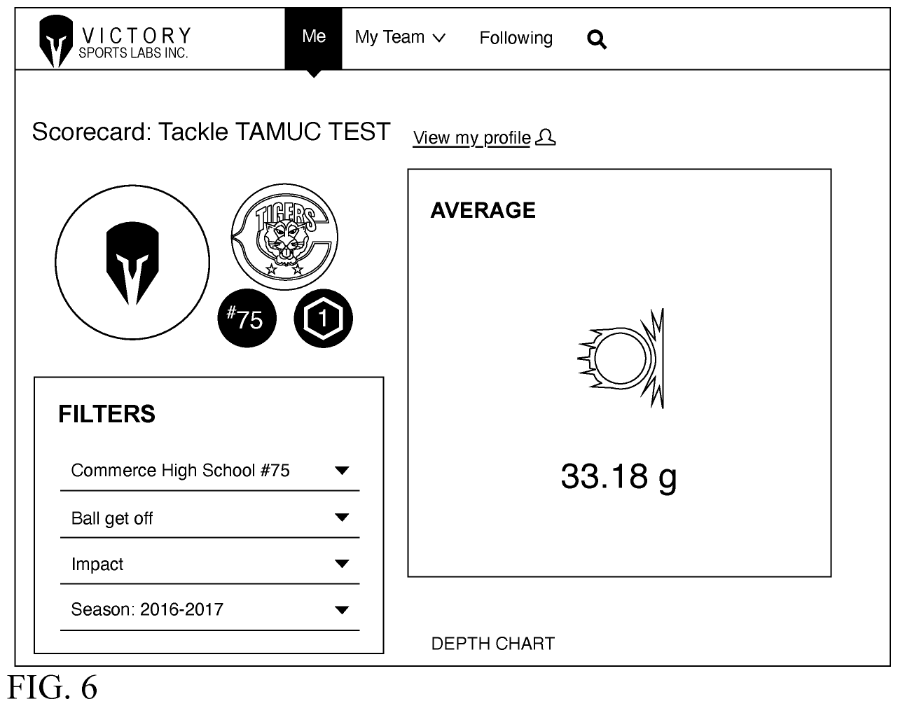

FIG. 6 provides an alternative exemplary view of an athlete's scorecard as displayed by the system. As shown, the athlete has selected the “ball get off” drill and has elected to measure impact, an average of which is shown over the course of the 2016-2017 season. The displayed athlete scorecard may also allow an athlete to monitor and update the athlete's demographic information and review and complete prescribed or additional training drills or exercises. The athlete, coach, recruiter, and other users are able to filter and drill down to various athlete rankings depending upon the different filters selected on the scorecard.

In some implementations, the system develops and delivers a prescriptive training plan to improve a user's athletic performance. Drills or exercises may be input into the system and may be divided into a plurality of categories such as for example, basic, intermediate, and advanced. Over time new drills may be added to the system and existing drills removed to continue to provide variety and comprehensive athletic performance improvement among users. In some implementations, an athlete completes a standardized introductory set of drill or exercise sessions. Based upon the athlete's performance results during this baseline and conditioning period, the system assigns an appropriate category of one or more drills or exercises to the athlete. In some embodiments, the system assigns a same set of initial drills to each athlete and in other embodiments, the system may assign an initial or subsequent set of drills based on criteria such as an athlete's selected sport, an athlete's selected position, and an athlete's selected fitness goal.

By way of non-limiting example, suppose the athlete whose scorecard is depicted in FIG. 5 was initially assigned a set of drills from among the “basic” category. As the athlete performs the drills over time, the system will record performance data such as reaction time and impact scores. A reaction time decrease and an impact score increase are indicators of improvement in athletic performance. As such, the system monitors the athlete's performance and determines whether the athlete's performance is consistently following an improvement curve (e.g. a growth curve for impact score and/or a decay curve for reaction time) after each day's drills are performed. Athletes who continue to perform with consistent improvement within a predetermined percentage range of an expected value for the athlete's performance data continue to advance through other drills of increasing difficulty as assigned by the system.

In some implementations, when an athlete scores higher than the expected range of improvement on one or more drills for a day, the system then assigns one or more drills that are nonidentical to the drills previously completed by the athlete, but that are of a similar level of difficulty and test similar skills to validate the previously observed improvement. If the improvement is validated, the system then prompts the athlete to bypass or otherwise omit the number of additional training sessions that would have been needed to meet the athlete's current demonstrated level of performance.

In some implementations, when an athlete scores lower on one or more drills than the expected range of improvement, the system then assigns one or more drills that is nonidentical to the drills previously completed by the athlete, but that are of a similar level of difficulty and test similar skills to validate the previously observed regression. If the regression is validated, the system then assigns a series of less difficult drills such as “basic” drills to the athlete's training regimen to assist the athlete in catching up to the athlete's expected level of performance. Once the system detects that the athlete's performance data is within the expected range of improvement, the system may remove the less difficult drills from the athlete's training regimen. The system may continue to monitor for any detected and/or validated regression in athletic performance and assign less difficult or “catch up” drills at any time during the athlete's training regimen.

In some embodiments, multiple types of performance data (e.g. reaction time and impact score, among others) may be collapsed into a single number that may be used to rank athletes such as, for example, into an “explosiveness score”, which may be based at least in part on the G-forces measured by the gyroscope and/or magnetometer (impact score) and the reaction time measured by the accelerometer. The individual performance data components may be combined into the explosiveness score using any variety of weighting of the various score components. Explosiveness scores may then rank within a predetermined range to allow for ranking of athletes based on this combined, weighted overall performance score.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “an” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

It will be understood that embodiments and implementations described and illustrated herein are not limited to the specific components disclosed herein, as virtually any components consistent with the intended operation of a method and/or system implementation for athletic performance training and assessment systems may be utilized. In places where the description above refers to particular embodiments of a athletic performance training and assessment system and usage techniques, it should be readily apparent that a number of modifications may be made without departing from the spirit thereof and that these implementations may be applied to other such systems and components. The presently disclosed implementations are, therefore, to be considered in all respects as illustrative and not restrictive.

The implementations listed here, and many others, will become readily apparent from this disclosure. From this, those of ordinary skill in the art will readily understand the versatility with which this disclosure may be applied.

We claim:

1. An athletic performance training and assessment system comprising:
a computerized mobile device comprising:
an input device configured to receive one or more demographic characteristics of an athlete and a selection of one or more athletic training drills by the athlete;
an accelerometer configured to measure linear acceleration of the athlete;
a gyroscope configured to measure angular velocity of the athlete; and
a magnetometer configured to detect an orientation of the computerized mobile device;
a processor configured to:
calculate a reaction time of the athlete using data obtained from the gyroscope, magnetometer, and accelerometer, by comparing a baseline score measured prior to commencement of the athletic training drill with a time stamp of a first peak value above the baseline score after commencement of the athletic training drill;
receive a plurality of pressure readings from a pressure sensor comprising a strike magnitude and a strike time stamp and calculate an impact score for the athlete; and
calculate an athlete ranking based on reaction time and impact score; and
assign an athletic training drill based on at least one of the athlete ranking, the reaction time and the impact score previously collected by the processor;
a wireless interface configured to transmit the athlete ranking and data collected for the athlete during the athletic training drill to an athlete database; and
a display configured to display that athlete ranking and athletic drill training data.

2. The system of claim 1, wherein the impact score is based on motion occurring in three axes and is calculated as a square root of a sum of squares of a magnitude of each of the three axes.

3. The system of claim 1, wherein the athlete ranking is based on at least one of a team, a league, a division, and an age bracket.

4. The system of claim 1, wherein the input device is further configured to receive a time period input from the athlete over which the athletic training drill is repeated and the athlete ranking is generated based on at least one of an average reaction time and an average impact score over the time period.

5. The system of claim 4, wherein the processor is further configured to calculate at least one of an improvement or a diminishment in at least one of an average of a reaction time or an impact score of a most recent athletic training drill session as compared to the at least one of the average reaction time and the average impact score over the time period input by the athlete and display the at least one of the improvement or the diminishment on the display of the computerized mobile device.

6. The system of claim 5, wherein the processor is further configured to assign a validation athletic training drill to the athlete when the at least one of the improvement or diminishment in at least one of an average of a reaction time or an impact score is within an expected range for athletic training progress of the athlete.

7. The system of claim 6, wherein the processor assigns an athletic training drill of a greater difficulty level in response to a positive validation performance by the athlete on the validation athletic training drill.

8. The system of claim 6, wherein the processor assigns an athletic training drill of a lesser difficulty level in response to a negative validation performance by the athlete on the validation athletic training drill.

9. The system of claim 5, further comprising displaying an athlete ranking for all athletes within the at least one of a team, a league, a division, or an age bracket.

10. The system of claim 5, wherein the processor is further configured to calculate an athletic performance score based on a weighted average of the reaction time and impact score of the athlete and generate and display an athlete ranking based on the calculated athletic performance score.

11. A method of athletic performance training and assessment comprising:
receiving, one or more demographic characteristics of an athlete and a selection of one or more athletic training drills by the athlete by an input device of a computerized mobile device, the computerized mobile device comprising:
an accelerometer configured to measure linear acceleration of the athlete;
a gyroscope configured to measure angular velocity of the athlete; and
a magnetometer configured to detect an orientation of the computerized mobile device;
calculating, by a processor of the computerized mobile device, a reaction time of the athlete using data obtained by the gyroscope, the magnetometer, and the accelerometer by comparing a baseline score measured prior to commencement of the athletic training drill with a time stamp of a first peak value above the baseline score after commencement of the athletic training drill;
receiving, by the processor, a plurality of pressure readings from a pressure sensor comprising a strike magnitude and strike timestamp and calculating an impact score for the athlete; and
calculating, by the processor, an athlete ranking based on the reaction time and the impact score;
transmitting, by a wireless interface, the athlete ranking and data collected for the athlete during the athletic training drill to an athlete database;
displaying, on a display of the computerized mobile device the athlete ranking and athletic drill training data; and
assigning, by the processor, an athletic training drill based on at least one of the athlete ranking and the athletic drill training data previously collected by the processor.

12. The method of claim 11, wherein the impact score is based on motion occurring in three axes and is calculated as a square root of a sum of squares of a magnitude of each of the three axes.

13. The method of claim 11, wherein the athlete ranking is based on at least one of a team, a league, a division, and an age bracket.

14. The method of claim 11, further comprising:
receiving a time period input from the athlete over which the athletic training drill is repeated; and
generating the athlete ranking based on at least one of an average reaction time and an average impact score over the time period.

15. The method of claim 14, further comprising:
calculating, by the processor, at least one of an improvement or a diminishment in at least one of an average of a reaction time or an impact score of a most recent athletic training drill session as compared to the at least one of the average reaction time and the average impact score over the time period input by the athlete; and
displaying the at least one of the improvement or the diminishment on the display of the computerized mobile device.

16. The method of claim 15, further comprising assigning, by the processor, a validation athletic training drill to the athlete when the at least one of the improvement or diminishment in at least one of an average of a reaction time or an impact score is within an expected range for athletic training progress of the athlete.

17. The method of claim 16, further comprising assigning, by the processor, an athletic training drill of a greater difficulty level in response to a positive validation performance by the athlete on the validation athletic training drill.

18. The method of claim 16, further comprising assigning, by the processor, an athletic training drill of a lesser difficulty level in response to a negative validation performance by the athlete on the validation athletic training drill.

19. The method of claim 15, further comprising displaying an athlete ranking for all athletes within the at least one of a team, a league, a division, or an age bracket.

20. The method of claim 15, further comprising:
calculating, by the processor, an athletic performance score based on a weighted average of the reaction time and impact score of the athlete; and
generating and displaying an athlete ranking based on the calculated athletic performance score.
